(19) United States
(12) Patent Application Publication
(10) Pub. No.: US 2009/0047467 A1
(43) Pub. Date: Feb. 19, 2009

(54) FLEXIBLE INSULATING MEMBER AND METHOD OF MANUFACTURING SAME

(76) Inventor: Frank Vaydik, Saginaw, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/838,516

(22) Filed: Aug. 14, 2007

(51) Int. Cl. B32B 3/06; B05D 1/02; B05D 3/12

(52) U.S. Cl. 428/100; 29/728; 427/290; 427/372.2; 427/421.1

(57) ABSTRACT

A method of manufacturing an insulating assembly includes the steps of securing a hook portion (38) of a hook and loop fastener (36) to the cloth (22), securing a support loop portion (42) of the hook and loop fastener (36) to a support (48), and removably securing the cloth (22) to the support (48) by securing the hook portion (38) of the fastener (36) to the support loop portion (42) of the fastener (36). The cloth (22) is then sprayed with the insulating material (50) and dried. To insulating the object (20), an aerogel material is placed about the object (20), the cloth (22) is placed about the material, and the first edge (32) of the cloth (22) is secured to the second edge (34) of the cloth (22) by securing the hook portion (38) of the fastener to the cloth loop portion of the fastener (36) on the cloth (22).

### BACKGROUND OF THE INVENTION

1. Field of the Invention

An insulating assembly for insulating an object and methods of manufacturing and using same.

2. Description of the Prior Art

Many methods of manufacturing insulating clothes are well known in the art. Examples of similar methods include U.S. Patent 2003-0129320 to Yu and U.S. Pat. No. 6,037,280 to Edwards et al.

The most pertinent patent found regarding the method is the Yu patent. The Yu patent discloses a method of spraying a ceramic coating onto a substrate to be old and well known. The ceramic particles are injected into a plasma jet directed toward the substrate. The jet causes the particles to melt, and upon impact on the substrate, form a ceramic layer.

The Edwards patent discloses a method of spraying UV protective particles onto cloth. Thereafter, allowing the cloth to dry is inherent in the patent. The cloth is then cut and sewn into many items including clothes, tents and tarps.

Many insulating clothes are well known in the art. Examples include U.S. Pat. No. 4,346,313 to Stengle Jr. and the Edwards patent.

The Stengle Jr. patent discloses a heat-resistant woven fabric substrate having a heat-resistant coating thereon. The fabric is flexible prior to the coating being applied and forms a hard condition upon application of the coating.

The Edwards, et al. patent teaches a piece of cloth having UV blocking particles that are bonded to the cloth by a bonding agent. Edwards also teaches a cloth shaped into an article of clothing, a tent, a canvas and the like, also having UV blocking particles and a bonding agent.

Although the prior art operates within its intended use, there is a need for an improved insulating assembly and alternative method of manufacturing an insulating assembly.

### SUMMARY OF THE INVENTION AND ADVANTAGES

An insulating assembly for insulating an object comprises a cloth, a fastener disposed on the cloth for fastening the cloth about the object, and a layer of material having insulating properties disposed on the cloth for insulating the object, wherein the layer of material flexible for allowing the cloth to conform to the object.

A method of manufacturing an insulating cloth includes the step of spraying the cloth with an insulating material. The method also includes the steps of securing a hook portion of a hook and loop fastener at a first edge of the cloth, securing a support loop portion of the hook and loop fastener to a support, and removably securing the cloth to the support by securing the hook portion of the fastener of the cloth to the support loop portion of the fastener of the support.

A method of insulating an object using a cloth comprises the steps of placing a material being aerogel about the object, placing the cloth about the material, and fastening the first edge of the cloth to the second edge of the cloth by securing the hook portion of the fastener to the loop portion of the fastener.

The invention provides an insulating cloth having increased insulating properties and a simplified method of insulating an object using the insulating cloth.

Additionally, the invention reduces the complexity of manufacturing an insulating cloth.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an embodiment of the insulating cloth;

FIG. 2 is a flow chart of an embodiment of the method of manufacturing the cloth;

FIG. 3 is a cross sectional side view of the embodiment of FIG. 1 illustrating the cloth after the removably securing step; and

FIG. 4 is a cross sectional view of the embodiment of FIG. 1 illustrating the cloth placed about a tubular object and after the fastening step.

### DETAILED DESCRIPTION OF THE INVENTION

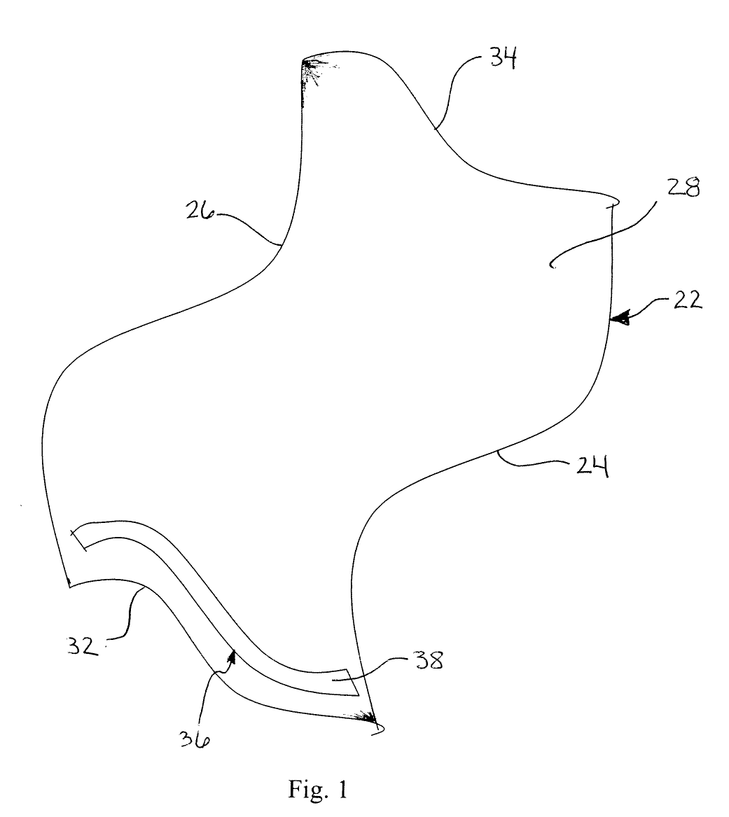

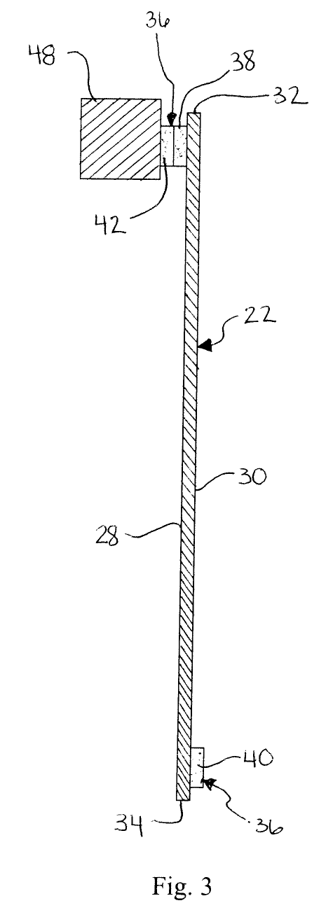

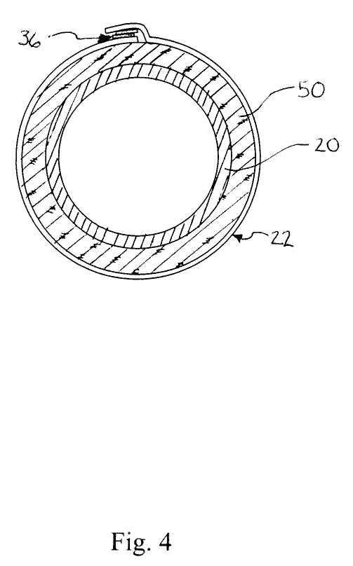

An insulating assembly for insulating an object 20 is shown alone in FIG. 1, shown during the method of manufacturing in FIG. 3, and shown in use in FIG. 4. A cloth 22, 20 generally indicated, defines a right side 24 and a left side 26 and a first surface 28 and a second surface 30. A first edge 32 extends between the sides 24, 26 and a second edge 34 opposite the first edge 32 extends between the sides 24, 26. The cloth 22 includes fiberglass and cloth fibers, however the cloth 22 may be any material, preferably a material having insulating properties.

A fastener 36, generally indicated and of the type having a hook portion 38 and a cloth loop portion 40, is disposed on the cloth 22 for fastening the cloth 22 about the object 20. The hook portion 38 of the fastener 36 is disposed adjacent the first edge 32 of the cloth 22 and extends between the sides 24, 26 of the cloth 22. The cloth loop portion 40 is disposed adjacent the second edge 34 of the cloth 22 and extends between the sides 24, 26 of the cloth 22. Both the hook and cloth loop portions 38, 40 of the fastener 36 extend along the entire length of the edge of the cloth 22. The hook and loop fastener 36 may be the product sold under the trademark Velcro(V but one skilled in the art will recognize many other forms of fasteners 36 may be substituted, such as multiple elongated pieces or ties on each edge of the cloth 22. In addition, the hook and cloth loop portions 40, 42 may be reversed, wherein the hook portion 38 is disposed adjacent the first edge 32 and the cloth loop portion 40 is disposed adjacent the second edge 34.

A layer of material 44 is disposed on the cloth 22 and extends between the fibers of the cloth 22 for insulating the object 20. The material 44 surrounds each fiber, is disposed in the pockets between the fibers, and may form a layer of material 44 surrounding the entire cloth. The layer of material 44 has insulating properties, such as ceramic, and is flexible for allowing the cloth 22 to conform to the object 20. The layer of material 44 may also have water resistant properties. The layer of material 44 is preferably a flexible ceramic, for example, the product sold under the trademark CCS-100™.

Threads 46 are disposed along the edges 32, 34 of the cloth 22 and the sides 24, 26 of the cloth 22 for finishing the edges 32, 34 and the sides 24, 26. The threads 46 have a layer of fluoropolymer resins disposed thereabout. The threads 46 are sewn into the material after the cloth 22 has been cut into predetermined patterns.

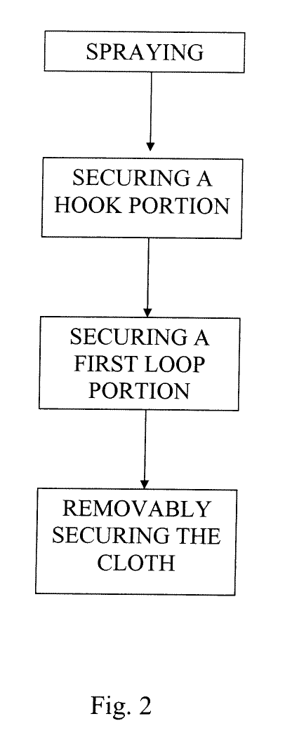

A method of manufacturing the insulating cloth 22 is illustrated in FIGS. 2 and 3. FIG. 2 is a flow chart showing one embodiment of the method of manufacturing the insulating assembly. FIG. 3 is a cross sectional view of one embodiment of the insulating assembly while the assembly is mid-way through the method of manufacturing, specifically, after the insulating assembly is removably secured to a support 48. The method includes the step of first cutting the cloth 22 to a predetermined size. The predetermined size will depend on the facilities available for manufacturing the cloth 22 as well as the intended end product.

As shown in FIG. 2, the hook portion 38 of the hook and loop fastener 36 is secured at the first edge 32 of the cloth 22. A support loop portion 42 of the hook and loop fastener 36 is secured to the support 48. The support 48 is horizontal, as shown in FIG. 3, and the support loop portion 42 extends horizontally along the support 48. The cloth 22 is removably secured to the support 48 by securing the hook portion 38 of the fastener 36 of the cloth 22 to the support loop portion 42 of the fastener 36 of the support 48.

The cloth loop portion 40 of the hook and loop fastener 36 of the cloth 22 is secured to the second edge 34 of the cloth 22 opposite the first edge 32 of the cloth 22, as best illustrated in FIG. 3. The cloth loop portion 40 may be secured after the cloth 22 is removably secured, however, it is preferable to secure the cloth loop portion 40 prior to the cloth 22 being removably secured to the support 48.

A material, such as a ceramic material that is flexible when dry, e.g., the product sold under the trademark CCS-100™, is sprayed onto the cloth 22 for absorption by the cloth 22. The material-coated cloth 22 is then dried by blowing air over the cloth 22 while the cloth 22 is secured. Drying may be performed using a conventional fan supported on the floor near the hanging cloth 22. The cloth 22 may instead be air dried. Regardless of the method of drying, the cloth 22 absorbs the flexible material as the cloth 22 dries. Multiple layers of ceramic material may be sprayed onto the cloth 22.

After the cloth 22 is dried, the cloth 22 is removed from the support 48 by separating the hook portion 38 of the fastener 36 of the cloth 22 from the support loop portion 42 of the fastener 36 of the support 48. The cloth 22 of the predetermined size is cut and sewn into application-dependant predetermined patterns. These patterns will directly depend on the object 20 being insulated by the cloth 22.

In operation, after the cloth 22 is manufactured, an aerogel material 50 is placed about an object 20 to be insulated. Aerogel is a low-density solid-state material wherein the liquid component of a gel is replaced with gas. The aerogel material 50 may be based on silica, alumina, chromia, tin oxide, carbon, or other known materials. The insulating cloth 22 is then placed over the material 50 and the object 20 such that the cloth 22 encloses both the object 20 and the insulating material 50. The first edge 32 of the cloth 22 is fastened to the second edge 34 of the cloth 22 by securing the hook portion 38 of the fastener 36 of the cloth 22 to the loop portion of the fastener 36 of the cloth 22, as shown in FIG. 4.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. The use of the word “said” in the assembly claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A method of manufacturing an insulating cloth (22) comprising the steps of;
spraying a material onto a cloth (22) for absorption by the cloth (22), characterized by
securing a hook portion (38) of a hook and loop fastener (36) at a first edge (32) of the cloth (22),
securing a support loop portion (42) of the hook and loop fastener (36) to a support (48),
removably securing the cloth (22) to the support (48) by securing the hook portion (38) of the fastener (36) of the cloth (22) to the support loop portion (42) of the fastener (36) of the support (48).

2. A method as set forth in claim 1 including the step of removing the cloth (22) from the support (48) by separating the hook portion (38) of the fastener (36) of the cloth (22) from the support loop portion (42) of the fastener (36) of the support (48).

3. A method as set forth in claim 1 including the step of securing a cloth loop portion (40) of the hook and loop fastener (36) of the cloth (22) to a second edge (34) of the cloth (22) opposite the first edge (32) of the cloth (22).

4. A method as set forth in claim 1 including the step of cutting the cloth (22) into predetermined patterns.

5. A method as set forth in claim 4 including the step of sewing the cloth (22) into predetermined patterns in response to said cutting the cloth (22).

6. A method as set forth in claim 1 including the step of drying the cloth (22).

7. A method as set forth in claim 6 wherein said drying is further defined as blowing air over the cloth (22).

8. A method as set forth in claim 6 including the step of repeating said spraying step and said drying step.

9. A method as set forth in claim 1 including the step of cutting the cloth (22) to a predetermined size prior to said spraying step and prior to said securing steps.

10. A method of manufacturing an insulating cloth (22) comprising the steps of,
cutting a cloth (22) to a predetermined size,
spraying a material onto the cloth (22) for absorption by the predetermined size,
blowing air over the predetermined size for drying the predetermined size,
cutting the cloth (22) into predetermined patterns,
sewing the cloth (22) into predetermined patterns in response to said cutting the cloth (22) step, and
characterized by
securing a hook portion (38) of a hook and loop fastener (36) to a first edge (32) of the cloth (22),
securing a support loop portion (42) of the hook and loop fastener (36) to a horizontal support (48),
securing a cloth loop portion (40) of the hook and loop fastener (36) to a second edge (34) of the cloth (22) opposite the first edge (32) of the cloth (22),
removably securing the predetermined size to the horizontal support (48) by securing the hook portion (38) of the fastener (36) to the support loop portion (42) of the fastener (36) prior to said spraying, and
removing the predetermined size from the horizontal support (48) by separating the hook portion (38) of the fastener (36) of the cloth (22) from the support loop portion (42) of the fastener (36) of the support (48) following said blowing.

11. A method of insulating an object (20) using a cloth (22) having a hook portion (38) of a fastener (36) on a first edge (32) of the cloth (22) and a cloth loop portion (40) of the fastener (36) on a second edge (34) of the cloth (22) and a layer of flexible insulating material disposed on the cloth (22) and comprising the steps of,
placing an aerogel material (50) about the object (20);
placing the cloth (22) about the material; and fastening the first edge (32) of the cloth (22) to the second edge (34) of the cloth (22) by securing the hook portion (38) of the fastener (36) to the cloth loop portion (40) of the fastener (36).

12. An insulating assembly for insulating an object (20) comprising;
a cloth (22),
a fastener (36) disposed on said cloth (22) for fastening said cloth (22) about the object (20),
a layer of material (44) having insulating properties disposed on said cloth (22) for insulating the object (20), and
said layer of material (44) being flexible for allowing said cloth (22) to conform to the object (20).

13. An insulating assembly for insulating an object (20) as set forth in claim 12 wherein said fastener (36) includes a hook portion (38) and a cloth loop portion (40).

14. An insulating assembly for insulating an object (20) as set forth in claim 13 wherein said cloth (22) has a first surface (28) and a second surface (30) and said hook portion (38) of said fastener (36) is disposed on said first surface (28) of said cloth (22) and said cloth loop portion (40) of said fastener (36) is disposed on said second surface (30) of said cloth (22).

15. An assembly as set forth in claim 14 wherein said layer of material (44) is ceramic.

16. An assembly as set forth in claim 15 wherein said cloth (22) defines a right side (24) and a left side (26) and a first edge (32) extending between said sides (24, 26) and a second edge (34) opposite said first edge (32) and extending between said sides (24, 26) and wherein said hook portion (38) of said fastener (36) is disposed adjacent said first edge (32) of said cloth (22) and extends between said sides (24, 26) of said cloth (22) and said cloth loop portion (40) is disposed adjacent said second edge (34) of said cloth (22) and extends between said sides (24, 26) of said cloth (22).

17. An assembly as set forth in claim 16 further including threads (46) disposed along said edges (32, 34) of said cloth (22) and said sides (24, 26) of said cloth (22) for finishing said edges (32, 34) and said sides (24, 26).

18. An assembly as set forth in claim 17 wherein said threads (46) have a layer of fluoropolymer resins disposed thereabout.

19. An assembly as set forth in claim 15 wherein said cloth (22) includes fiberglass and cloth (22) fibers and wherein said layer of material (44) extends between said fibers of said cloth (22).

20. An insulating assembly for insulating an object (20) comprising;
a cloth (22) including fiberglass and cloth (22) fibers and defining a right side (24) and a left side (26) and a first edge (32) extending between said sides (24, 26) and a second edge (34) opposite said first edge (32) and extending between said sides (24, 26) and having a first surface (28) and a second surface (30),
a fastener (36) disposed on said cloth (22) and including a hook portion (38) and a cloth loop portion (40) for fastening said cloth (22) about the object (20),
said hook portion (38) of said fastener (36) being disposed on said first surface (28) adjacent said first edge (32) of said cloth (22) and extending between said sides (24, 26) of said cloth (22) and said cloth loop portion (40) being disposed on said second surface (30) adjacent said second edge (34) of said cloth (22) and extending between said sides (24, 26) of said cloth (22),
a layer of material (44) disposed on said cloth (22) and extending between said fibers of said cloth (22) for insulating the object (20), and
said layer of material (44) being ceramic and being flexible for allowing said cloth (22) to conform to the object (20), and
threads (46) having a layer of fluoropolymer resins thereabout and disposed along said edges (32, 34) of said cloth (22) and said sides (24, 26) of said cloth (22) for finishing said edges (32, 34) and said sides (24, 26).
